(19) United States
(12) Patent Application Publication
(10) Pub. No.: US 2019/0094181 A1
(43) Pub. Date: Mar. 28, 2019

(54) METHODS AND SYSTEM FOR INSPECTING TRAIN WHEELS AND AXLES

(71) Applicant: PURE TECHNOLOGIES LTD., Calgary (CA)

(72) Inventor: Peter O. PAULSON, Calgary (CA)

(21) Appl. No.: 16/084,749

(22) PCT Filed: Mar. 17, 2017
(86) PCT No.: PCT/CA2017/050345

§ 371 Date: Sep. 13, 2018

Related U.S. Application Data
(60) Provisional application No. 62/310,392, filed on Mar. 18, 2016.

(51) Int. Cl. G01N 27/85; G01M 17/10; B61K 9/12; B61L 25/02

(52) U.S. Cl. CPC G01N 27/85; B61L 25/021; B61K 9/12; G01M 17/10

(57) ABSTRACT

The present invention relates to a method for identifying and locating a defect in a train wheel or an axle of a train as the train moves along a rail track, the method comprising the steps of: sampling magnetic field measurements obtained from a plurality of magnetometer sensors so arranged to be in proximity to a moving wheel or an axle, the sensors arranged to span at least a length sufficient to obtain the magnetic field measurements from the entire wheel or the axle during one complete revolution of the wheel or the axle; and identifying and locating a defect in the wheel or the axle when a sampled magnetic field measurement is equal to or exceeds a threshold value.

### RELATED APPLICATIONS

The present application claims priority to U.S. provisional application No. 62/310,392 filed Mar. 18, 2016, which is hereby incorporated by reference in its entirety.

### FIELD OF THE INVENTION

The present invention relates to analyzing a wheel and axle for defects, in particular to method and system for identifying and locating defects on a wheel and axle for defects.

### BACKGROUND

Damaged train wheels and axles are difficult and cumbersome to inspect. Current methods rely on visual inspection, flat spot detection using equipment that “listens” for the thumping caused by a wheel with a flattened portion as it rolls, ultrasonic inspection done manually, or combination thereof.

However, many of the current methods do not allow for quick and efficient analysis. The risks of mishap and derailments cannot be adequately detected and timely addressed.

As well, inspection of wheels and axles sometimes requires a train to be stopped and/or requires train vehicles to be sent to a designated place for inspection, such as a repair facility. This would decrease the utility rate of the train and reduce the transportation capacity of the train.

### SUMMARY OF THE INVENTION

According to one broad aspect, the present disclosure relates to a method for analyzing the wheel and axle for defects.

In one aspect the present disclosure provides a method for identifying and locating a defect in a train wheel or an axle of a train as the train moves along a rail track, the method comprising the steps of: sampling magnetic field measurements obtained from a plurality of magnetometer sensors so arranged to be in proximity to a moving wheel or an axle, the sensors arranged to span at least a length sufficient to obtain the magnetic field measurements from the entire wheel or the axle during one complete revolution of the wheel or the axle; and identifying and locating a defect in the wheel or the axle when a sampled magnetic field measurement is equal to or exceeds a threshold value.

According to an aspect, the threshold value is a value above or below background fluctuations in the magnetic field measurements.

According to an aspect, the defect is in the wheel and wherein the length is a distance about equivalent to at least about one revolution of the wheel.

According to an aspect, the method further comprising the step of determining the speed of the wheel and the time the wheel passes in proximity to the plurality of magnetometer sensors.

According to an aspect, the method further comprising the steps of: plotting the sampled magnetic field measurements against distance or time to obtain a map showing the changes in magnetic field levels throughout the wheel; and analyzing the map to identify the defect on a section on the wheel.

According to an aspect, the step of analyzing the map comprises the steps of: determining the range of the changes in the magnetic field measurements during one complete revolution of the wheel; identifying one or more maxima in the sampled magnetic field measurements; generating a visual pattern using the range of magnetic field measurements; and identifying from the visual pattern, the center of the defect using the identified maxima.

According to an aspect, the generated visual pattern is a colour visual pattern.

According to an aspect, the method further comprising the step of comparing the levels of the magnetic field measurements sampled from a first array of magnetometer sensors arranged to face a field side of the wheel with the levels of the magnetic field measurements sampled from a second array arranged to face a gauge side of the wheel to determine whether the location of the defect is proximal to the field side or proximal to the gauge side.

According to an aspect, the method further comprising the step of calculating one or a plurality of gradients from the sampled magnetic field levels to determine if the location of the defect is proximal to the perimeter or to the center of the wheel.

In one aspect the present disclosure provides an apparatus for identifying and locating defects in a train wheel or an axle of a train as the train moves along a rail track, the apparatus comprising: a plurality of magnetometer sensors, the sensors arranged to measure magnetic field components in a plurality of directions, the sensors arranged in an array a length sufficient to measure the magnetic field components from the entire wheel or axle during one complete revolution of the wheel or axle.

According to an aspect, the defect is in the wheel and the length is a distance about equivalent to at least about one revolution of the wheel.

According to an aspect, the defect is in the axle and wherein the length is about the length of the axle.

In one aspect the present disclosure provides a system for identifying and locating defects in a train wheel or axle of a train as the train moves along a rail track, the system comprising: a plurality of magnetometer sensors, the sensors arranged to measure magnetic field components in a plurality of directions, the sensors arranged in an array having a length sufficient to measure the magnetic field components from the entire wheel or axle during one complete revolution of the wheel or axle; a processor; and a non-transitory computer readable media having instructions stored thereon which when executed cause the processor to: sample the magnetic field measurements; identify and locate a defect when a sampled magnetic field measurement is equal to or exceeds a threshold value.

According to an aspect, the system further comprising a data acquisition system for collecting the analog output signal of the sensors, an analog to digital converter for digitizing the analog output signal of the sensors, a memory, and processor arranged to write a plurality of sensor signals to the memory.

According to an aspect, the system further comprising a proximity sensor to detect the presence of the wheels.

According to an aspect, the system further comprising a hot box detector to associate the magnetic field measurements with an individual train wheel.

According to an aspect, the plurality of magnetometer sensors are arranged to face a field side of the wheel or a gauge side of the wheel, or both.

In one aspect the present disclosure provides a non-transitory computer readable medium having instructions stored thereon for identifying and locating defects in a train wheel or axle of a train as the train moves along a rail track, the instructions when executed cause a computer to: sample magnetic field measurements, the magnetic field measurements obtained from a plurality of magnetometer sensors so arranged to be in proximity to a moving wheel or axle, the sensors arranged to span at least a length sufficient to obtain the magnetic field measurements from the entire wheel or axle during one complete revolution of the wheel or axle; identify and locate a defect when a sampled magnetic field measurement is equal to or exceeds a threshold value.

According to an aspect, the non-transitory computer readable medium further comprising instructions, when executed additionally cause the computer to: plot the sampled magnetic field measurements against distance or time to obtain a map showing the changes in magnetic field measurements throughout the wheel; and analyze the map to identify the defect on a section on the wheel.

According to an aspect, the non-transitory computer readable medium further comprising instructions, when executed additionally cause the computer to: determine the range of the changes in the magnetic field measurements during one complete revolution of the wheel; identify one or more maxima in the sampled magnetic field measurements; generate a visual pattern using the range of magnetic field measurements; and identify from the visual pattern, the center of the defect using the identified maxima.

According to an aspect, the non-transitory computer readable medium further comprising instructions, when executed additionally cause the computer to: compare the magnetic field measurements sampled from a first array of magnetometer sensors arranged to face a field side of the wheel with the magnetic field measurements sampled from a second array arranged to face a gauge side of the wheel to determine based on the relative levels of the sampled magnetic field measurements whether the location of the defect is proximal to the field side or proximal to the gauge side.

According to an aspect, the non-transitory computer readable medium further comprising instructions, when executed additionally cause the computer to calculate one or a plurality of gradients from the sampled magnetic field levels to determine if the location of the defect is proximal to the perimeter or to the center of the wheel.

A method for identifying and locating the existence of a defect in a train wheel on a train as it moves along a rail comprising: positioning a first row of magnetic sensors along a length of the rail on a field side of a wheel and second row of magnetic sensors along a length of the rail on a gauge side of a wheel, each of said rows being at least a length equivalent to a wheel circumference; sampling magnetic field measurements from selected sensors along the row as a train wheel passes by; analysing the patterns of changes in magnetic fields along said row of sensors produced by each wheel; and identifying potential defects in the wheel based on analysis of said patterns.

According to another aspect of the present disclosure, there is provided a method for identifying and locating the position of a defect in a train wheel on a train as it moves along a rail. The method comprises positioning a first row of magnetic sensors along a length of the rail on a field side of a wheel and a second row of magnetic sensors along a length of the rail on a gauge side of a wheel, each of said rows having at least a length equivalent to a wheel circumference; sampling magnetic field measurements from each of said sensors; determining multiple magnetic field values over different pluralities of samples; identifying a defect in the wheel based on a change in one or more of the magnetic field values; and determining a position of the defect at a particular distance from the magnetic sensor on the wheel or axle based on a degree or rate of variation in the magnetic field.

### BRIEF DESCRIPTION OF THE DRAWINGS

FIG. 1 is a side elevation view of the system for identifying and locating defects on wheel and axle according to one embodiment of the present disclosure;

FIG. 2 is a top plan of the system of FIG. 1;

FIG. 3 is a cross sectional view along the line 2-2 in FIG. 2;

FIG. 4 is a schematic view of the system;

FIG. 5 is a perspective view of the system;

FIG. 6 is a flow chart showing a method of detecting a defect of a rail wheel, according to embodiments of the present disclosure

FIG. 7 is a plot of the analysis of a wheelset comprising wheels 7 and 8 from sensors placed on the gauge side of the wheels;

FIG. 8 is a plot of the analysis of a wheelset comprising wheels 7 and 8 from sensors placed on the field side of the wheels;

FIG. 9 is a plot of the analysis of a wheelset comprising wheels 15 and 16 from sensors placed on the gauge side of the wheels;

FIG. 10 is a plot of the analysis of a wheelset comprising wheels 15 and 16 from sensors placed on the field side of the wheels;

FIG. 11 is a plot of the analysis of a wheelset comprising wheels 1 and 2 from sensors placed on the gauge side of the wheels;

FIG. 12 is a plot of the analysis of a wheelset comprising wheels 1 and 2 from sensors placed on the field side of the wheels;

FIG. 13 is a plot of the analysis of a wheelset comprising wheels 13 and 14 from sensors placed on the gauge side of the wheels; and

FIG. 14 is a plot of the analysis of a wheelset comprising wheels 13 and 14 from sensors placed on the field side of the wheels.

### DETAILED DESCRIPTION

Reference will be made below in detail to exemplary embodiments of the invention, examples of which are illustrated in the accompanying drawings. Wherever possible, the same reference numerals used throughout the drawings refer to the same or like parts.

The present disclosure relates to the use of a non-destructive testing method known as the metal magnetic memory method (MMM). Non-destructive testing (NDT) is a group of testing procedures used to evaluate the properties of a test material without causing damage or destroying the serviceability of the material. One type of NDT is the metal magnetic memory (MMM) method.

The MMM technique is based on measurement and analysis of the distribution of self-magnetic-leakage-field (SMLF). The SMLF reflects the microstructure and technological history of metal components. For the equipment in operation, the magnetic memory appears in the irreversible change of the magnetization of the material in the direction of maximal stresses due to working loads.

In other words, MMM is a term applied to the remnant magnetism resulting from a history of stress cycling, and includes the dynamic magnetic fields created only while the item of interest is actively under stress.

The present disclosure derives from an understanding that it is possible to determine the presence of one or more defects in a structure, such as a wheel or an axle of a train, caused for example by repeated stress, by measuring changes in the magnetic field levels or their gradients in the vicinity of the structure. The defects have been found by the present inventors to cause detectable changes in the magnetic field levels or their gradients wherein each defect will generate a dipole magnetic field with the origin of the dipole field centered on the defect. The appearance of the dipole magnetic field above a background magnetic field and beyond a threshold value can be used to identify regions of high and/or abnormal stress and thereby identify regions for which further investigation or repair/maintenance are needed.

To allow the stakeholders to make quick and efficient judgment about how urgently a damaged train wheel and/or axles needs to be removed from service, the present method and system provides for certain advantages over current methods and systems. In one embodiment, the use of MMM sensing for wheels and axles would be advantageous because using the present method and system, users may detect defects in any one specific wheel or axle of a set of train wheels as the train passes stationary magnetometer sensors according to an embodiment of the present disclosure. Use of the present method and system avoids situations of having to place individual sensors on or near each wheel or axle or the need to stop the train in order to assess the condition of the train's wheels or axles.

The present method and system is also advantageous because according to the embodiment of the disclosure, the user may be able to further characterize the nature of the damage in each wheel or axle.

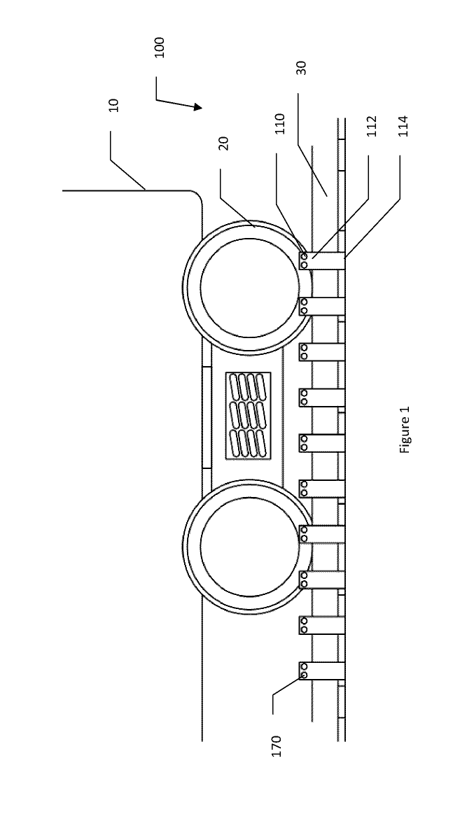

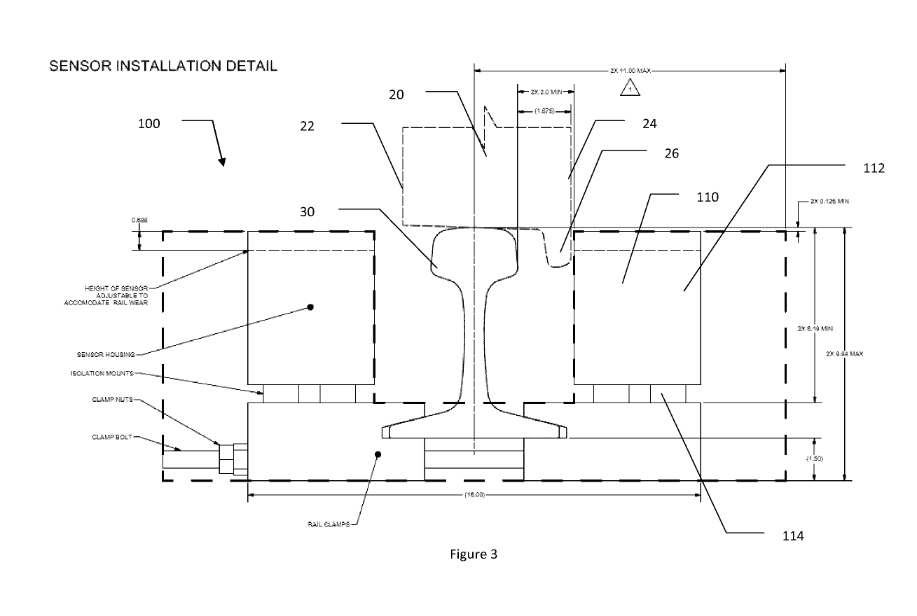

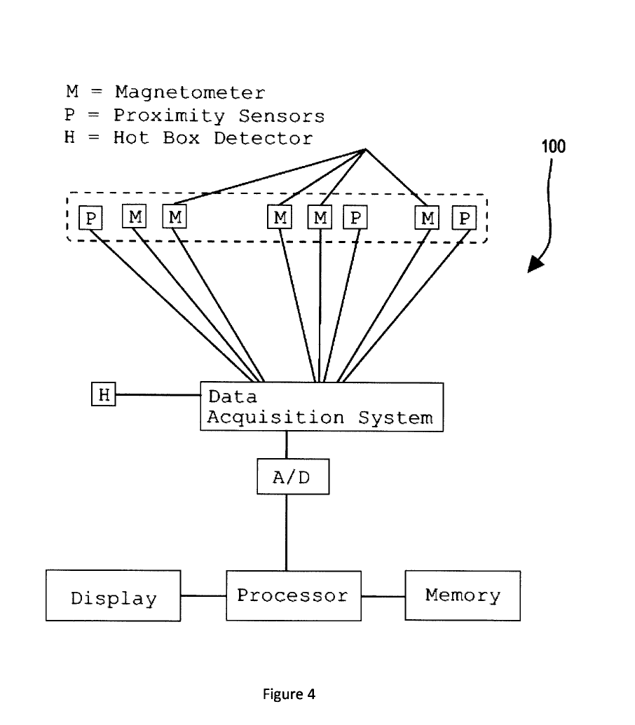

A system 100 for identifying and locating the existence of a defect in a structure found in the under-body of a railed vehicle, such as a train wheel or an axle, is depicted in FIGS. 1 to 5. Shown in FIG. 1 is a railed vehicle 10, such as a railway car, for carrying freight and/or passengers. Vehicle 10 comprises a plurality of axles (not shown) in between a pair of wheels 20 for rotatably supporting vehicle 10 over a pair of rail tracks 30. With reference to FIG. 3, each individual wheel can be understood as having a field side 22 which is outward facing and an opposing gauge side 24 which is inward facing and faces an opposed wheel. Wheels also include a flange 26 associated with the gauge side 24 for keeping the train 10 aligned with the rail tracks 30.

In one embodiment, system 100 comprises a plurality of magnetic field sensors (also known as magnetometers) 110 arranged in a linear array and in a parallel relationship to rail 30 and to the vehicle's direction of travel. Sensors 110 can be arranged to span at least a length of rail 30 sufficient to obtain magnetic field measurements from the entire wheel 20 during one complete revolution of wheel 20. Train wheels 20 are typically about 3 feet in diameter and about 10 feet in circumference. Therefore, according to one embodiment, the linear array of sensors 110 may for example be about 10 feet long so that each portion of the wheel diameter can be in sufficient proximity to the sensors such that the sensors are able to obtain magnetic field measurements as the wheel 20 passes the stationary sensors.

There exists a large amount of steel in any railway vehicle. This steel might interfere with accurate interpretation of the magnetometer data due to transient effects of other portions of the train vehicle. This interference can be mitigated efficiently by extending the length of the row of magnetometers 110 to a distance equal to or greater than the distance the wheel rolled through two or more complete revolutions of the wheel 20. Effects that are associated with the rolling wheel will correlate precisely over the course of the two revolutions, but the interference from other influences will not. The use of an auto-correlate function, for example, could extract the meaningful information from the received signal efficiently.

In one embodiment, the system 100 comprises enough sensors to allow one full circumference of a wheel to be covered. In other embodiments, the system 100 comprises a length of magnetic sensors 110 equivalent to the length of two full circumferences of wheel 20 to provide enough data to test repeatability because the track 30 itself can have an effect on the signals as the train 10 passes. Signals that do not match between the first revolution and the second revolution would be caused by other sources and not the wheel 20 and can be cancelled out.

Sensors 110 according to an embodiment of the present disclosure may comprise directional magnetometers which each measure the magnetic field components in the X, Y, and Z directions (e.g. tri-axial magnetometers). In this embodiment, the sensors create an analogue voltage output that is proportional to the magnetic field component in each X, Y, and Z direction. Other types of magnetometer sensors known to those in the art would also be suitable such as for example, 1 and 2-axis magnetometers (e.g. Honeywell model No. HMC1022).

Adjacently spaced sensors 110 can be placed at intervals of a few inches to detect changes in the magnetic fields when the wheels roll past the row of sensors 110. Generally, the intervals may be between 2 inches to 6 inches between every two magnetic field sensors 110. Each sensor may also be configured and have sufficient sensitivity to measure the magnetic field of a plurality of nearby wheels. It is preferable that sensors 110 be equally spaced apart from adjacent sensors 110, however, it is possible to use unequally spaced apart sensors 110.

Sensors 110 arranged in the linear array may be placed adjacent the rail track 30 such that the sensors 110 can be in close proximity to either the field side 24 or the gauge side 26 of each wheel 20, or both.

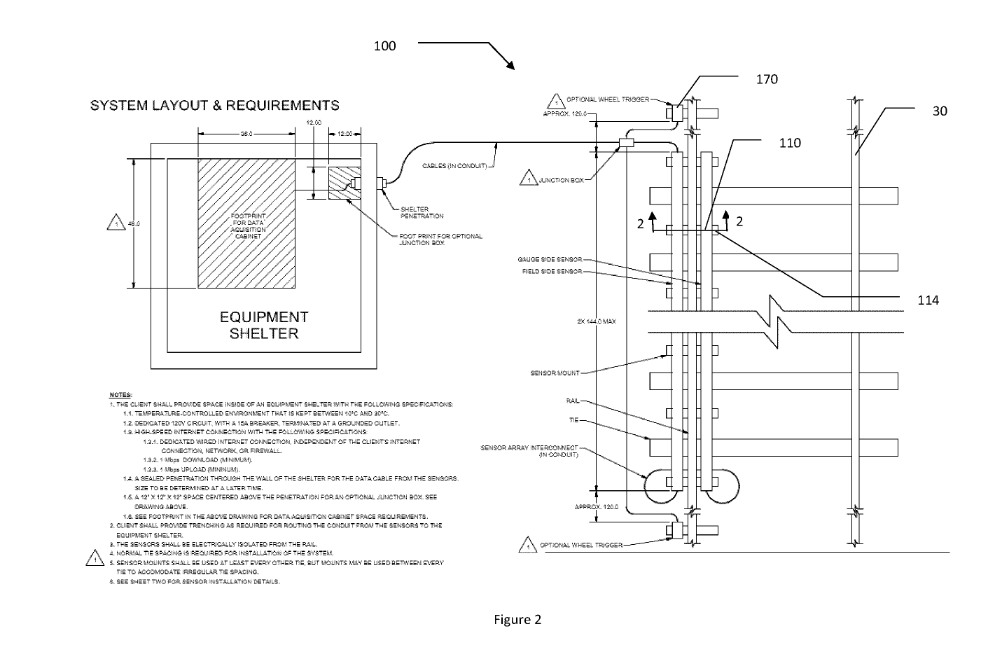

As shown FIGS. 2 to 5, two rows of sensors 110 placed along a rail, one placed facing the gauge side 26 of the wheel and the other facing the field side 24 of the wheel, may provide better sensitivity to flaws on either side of the wheel 20.

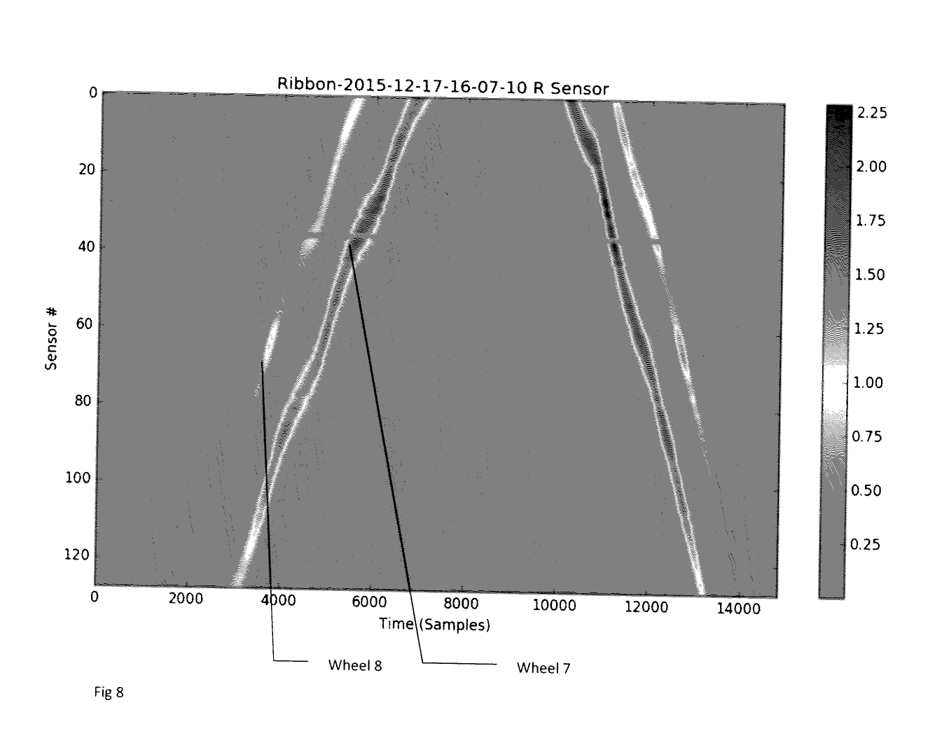

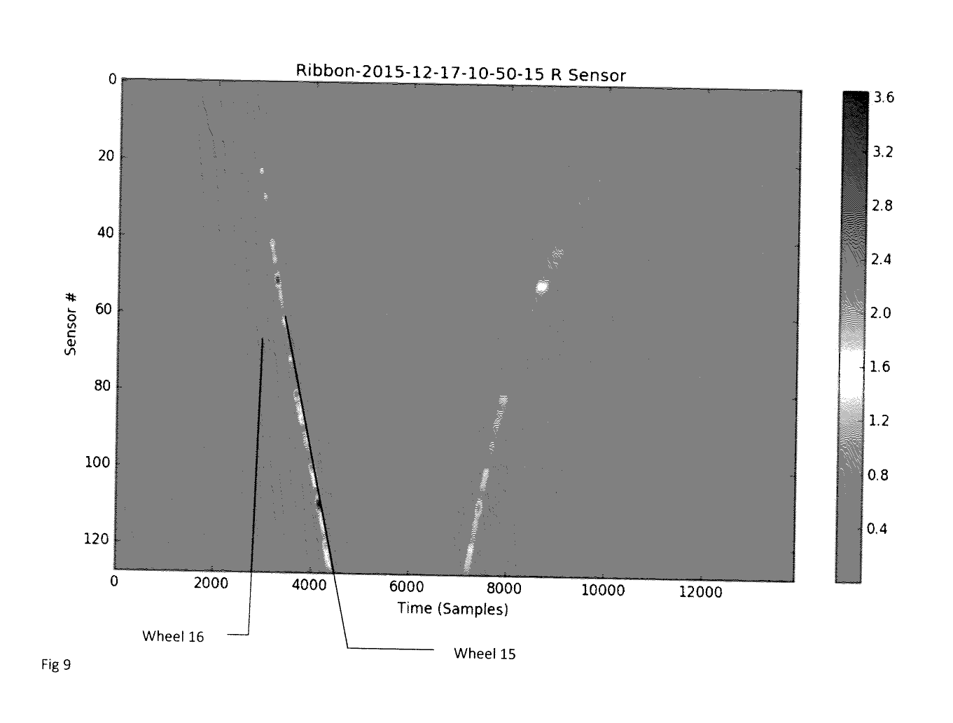

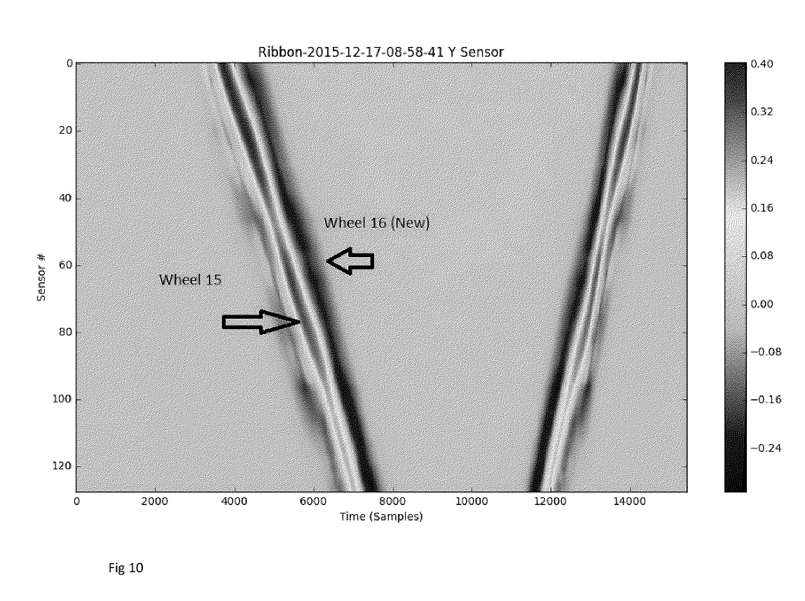

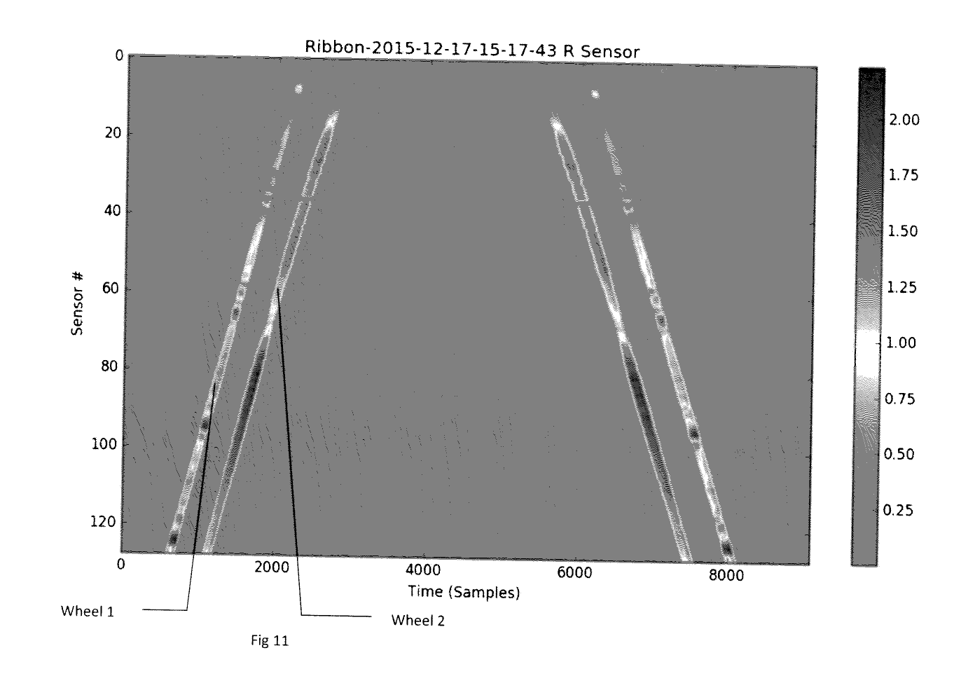

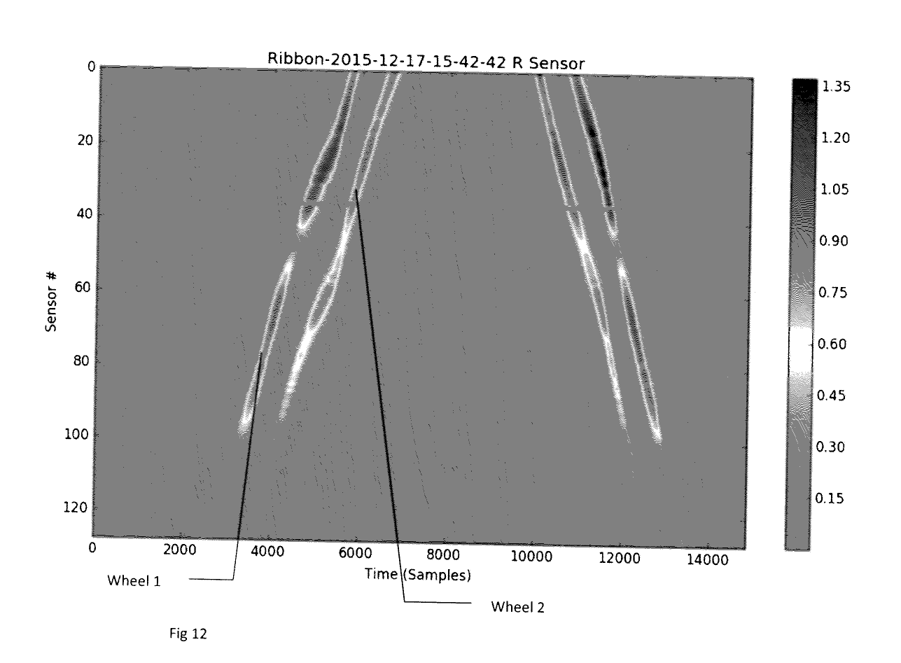

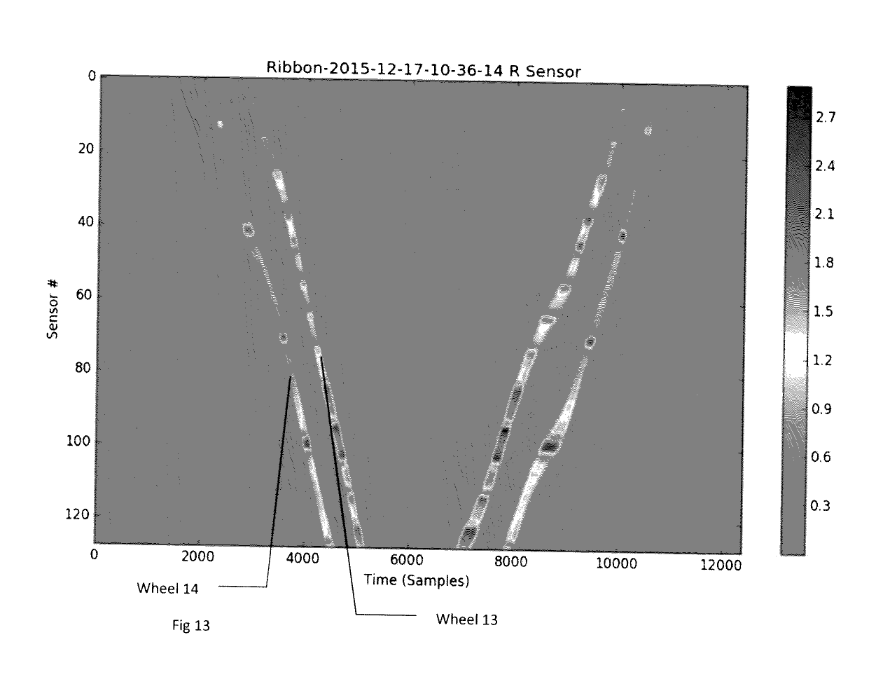

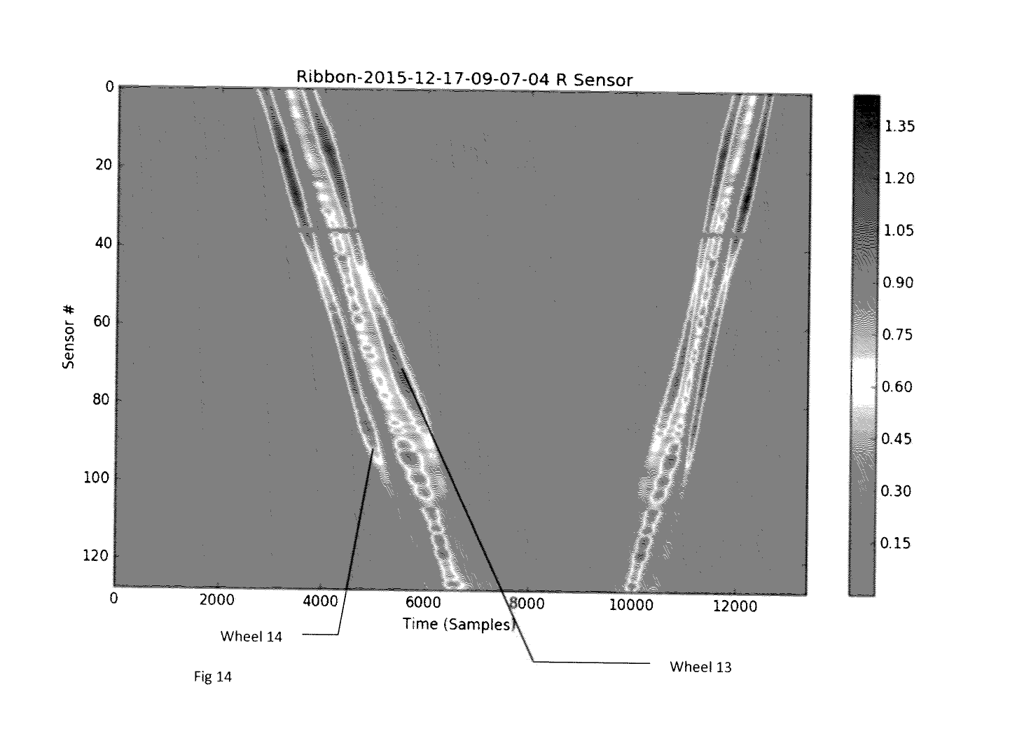

The placement of the magnetic field sensors facing both on the field side 24 and the gauge side 26 of each wheel 20 can allow some assessment of the estimation of the position (left and right) across the wheel 20 that the damage might have occurred. In this embodiment, the arrangement may also assist in the identification of the nature of the flaws as determined from the changes in the magnetic field levels or their gradients in the vicinity of wheel 20 as will be described in further detail in the following paragraphs and with reference to FIGS. 1 to 14. For example, if a flaw appears much larger on the field side 24 of the wheel relative to than on the gauge side 26, then the flaw is likely to be in the portion of the wheel called the rim which is proximal to the field side of the track. Flaws in the gauge side 26 of wheels 20 have shown to be larger than on the field side 24, an effect which may be caused by the “shielding” effect of the rim of the wheel.

In some embodiments, there may be 2 pairs of linear array of sensors 110 (i.e. one pair of the array of sensors associated with each rail of the trail track) at one or more sections of the rail track. In one embodiment, the sensor 110 and the wheel 20 can be separated by a distance of about 1″ to 2″ or preferably about 1.5″ to about 1.876″. The distance between sensor 110 and wheel 20 can be at any sensing range that permits the sensor 110 to detect changes in the magnetic field in the vicinity of wheel 20.

Sensors 110 are housed in a protective housing 112 and mounted to a support structure 114.

In one embodiment, the sensors 110 on the field side can be placed at approximately the same height as the height of the rail 30. In some embodiments, it is not necessary for the height on sensors 110 on the gauge side to exactly match the height on the field side.

In one embodiment, the sensors 110 may usefully be numbered/wired in sequence so that the magnetic field or the field gradient can be more readily derived spatially. The relative position of wheel 20 can be determined based on the overall positional changes in the pattern of the data received.

In an embodiment, the system further comprises a data acquisition system 120 for collecting the analog output signal of the sensors, an analog-to-digital converter (ADC) 130 for digitizing the analog output signal of the sensors, a non-transitory computer readable memory 140 having instructions stored thereon, a processor 150 arranged to write a plurality of digitized sensor signals to the memory, and a display 160 for displaying the output to a user.

The method and system of the present disclosure for train wheel assessment is non-contact and can be executed with the train moving at high speed past the stationary sensors 110. The sampling rate used to interrogate the sensors 110 needs to be fast enough to obtain data from each sensor 110 as the wheel 20 passes. For example, the sampling rate of the magnetometers 110 generally is one or more samples for each inch of travel of the wheel 20.

In an embodiment, the data acquisition system 120 may be a multiplexed data acquisition system sampling at about 200 samples/second/sensor. The system comprises 96 sensors. The multiplexing may occur in printed circuit boards (PCB) on which the sensors are mounted to minimize the number of wires going to the data acquisition system 120. The ADC 130 may be a high speed National Instruments card running on a usb linked to a computer.

In one embodiment, the velocity that each wheel passes each sensor can be determined with the rate of progress of the disturbances along the sensor array. As the length of the row of sensor 110 are known, the time and period of the disturbances of the magnetic field signals caused by the passage of the wheelset (4 wheels as a set with two tandem wheels on each side), which corresponds with the time period of the passage of the wheelset, can be observed based on the magnetic field signals collected. The velocity of the wheelset (and thus each wheel) can be calculated based on the length of the row of the sensors and the period of the passage of the wheelset.

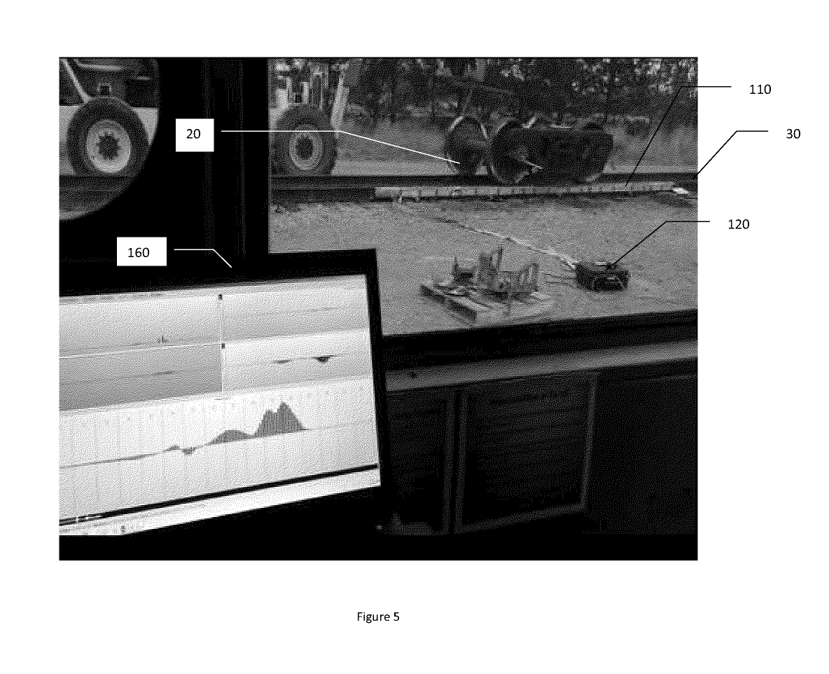

As shown in FIG. 5, each individual sensor 110 collects magnetic field signals (amplitude and/or direction) related to the train wheels 20 as the wheels 20 move past the row of stationary sensors 110 arranged in a linear row along side of a section of track 30. If there is a desire to assign the collected magnetic field signal to a specific wheel 20, then one way would be to establish the time that that wheel 20 passes each sensor 110.

In one embodiment, electromagnetic proximity sensors 170 are provided to detect the presence of pair of wheels nearby without physical contact. This can be used to determine the time, period, and velocity of each pair of wheels (and thus each wheel) passing the proximity sensor. For example, proximity sensors 170 can be inductive proximity sensors 170 with sensing range—up to 29 mm. in 2-wire AC and 3-wire DC models (http://www.omega.ca/googlebase/product en.html?pn=E59-M30C129C02-D1&gclid=CI3Qs771xsMCFYeBfgod0UkAjw). Based on the relative positions of the proximity sensors 170 and the magnetometers 110, the time, period, and velocity of each pair of wheels 20 (and thus each wheel) passing by the row of the magnetometers 110 may be determined, if necessary.

In another embodiment, one proximity sensor 170 is used with each row of the sensors 110. Because the wheels 20 arrive in pairs across from each other, the proximity sensor 170 knows when each axle, bearing two wheels, passes the proximity sensor 170. This is repeated for each axle. Therefore, the period for every two axles passes the proximity sensor 170 can be determined. Accordingly, the velocity can be determined by simply knowing the distance between axles.

In an embodiment, the proximity sensor 170 is placed at each end of the row of sensors/magnetometers 110 and to use the time of passage to gauge velocity and calculate the time that each wheel 20 passes each sensor/magnetometer. Proximity sensors 170 may be placed in positions near some or all of the magnetometer sensors 110. When proximity sensors 170 are used, at least one proximity sensor 170 is needed for the installation of one or two rows of magnetic sensors 110, if one rail is to be tested, or three to four rows of magnetic sensors 110, if two rails are to be tested.

Both the magnetometer sensors 110 and proximity sensors 170 should to be placed in a manner so that the train wheels 20 are within the reliable sensing ranges of both types of sensors. The magnetic sensors 110 and proximity sensors 170 can be placed as close to the track as practical without endangering the sensors. For example, one to two inches away from the wheels 20 for both types of sensors is a suitable distance.

In an embodiment, at least one side of one rail would have such sensors to determine the position and motion of each wheelset. This helps in assigning the signals detected to the wheel that causes the signals.

In an embodiment, an array of proximity sensors 170 is placed along the row of magnetometers/sensors 110 to allow more precise detection of the motion of the train wheels 20. A subset of this arrangement would be to place a proximity sensor 170 together with each magnetometer 110 as shown in FIG. 1 along and above the rail track. Only one side of one rail needs to be instrumented with proximity sensors 170, because the train wheels always arrive in pairs. A special advantage of the placement of proximity sensors 170 with each magnetometer 110 along at least one row of magnetometers/sensor is that complex motion of the train, such as stopping, reversing and speed changes can be easily detected.

In an embodiment, the magnetometer sensing array may be combined with Hot Box detector sites 180 to associate the magnetic features detected with individual wheels identities. Hot Box detectors 180 are currently available for railways to identify wheel bearings that are overheating. Some of these detectors 180 also can scan individual railcars and identify exactly which wheel on which axle is passing the detectors 180 at any given time. The speed of the wheels 20 can be determined based on the times the axles of a wheelset passing by the Hot Box detector 180. This information would then be relayed to a remote site for action when required.

Defects detected can be associated with individual rail cars and hence individual wheels through the use of rail car identifying scanners 180 which are commonly available. Such a scanner 180 would be connected to the processor examining the magnetometer data and the data would be associated with individual wheels.

This association allows an important advantage. If the train wheel exhibiting damage can be detected on more than one occasion, then the progress of the damage over time can be tracked. This progression of damage is valuable in making management decisions as to the necessity of removing a damaged wheel from service, or allowing it to operate for a time.

A similar system and method as described above can be used to examine the condition of the axles of the wheel-sets as they pass an array of sensors 110. For example, an array of sensors 110 can be arranged to span a length sufficient to obtain the magnetic field measurements across the ends of an entire axle during one complete revolution of the axle. In one embodiment, a row of sensors 110 can be arranged to a span a distance equal to about the length of an axle with the row aligned in relationship transverse to the railway car's direction of travel. Sensors 110 would be directed upwards and towards the axle so that sensors 110 are able to detect changes in the magnetic field levels to identify one or more defects in the axle. In one embodiment, the row of sensors 110 is moved up and into proximity to an axle as the railway car passes above. Once the measurements are taken, the row can be retracted and out of the way using various known mechanical arrangements.

In some embodiments, by virtue of the standards used to assemble and arrange axles in railway cars, it is possible to identify specific wheels 20 and wheelsets by simply examining the sequence of magnetic field data obtained from the wheels and/or the axles as the railcar 10 passes the stationary sensors 110. This information could be used in addition to information that is collected from the optional proximity 170 and/or hot box detectors 180 to collect information on the condition of the railcar's wheels and axles.

Using the methods and system of the present disclosure, the wheels can roll by the magnetometer 110, and proximity sensors 170 or Hot Box detectors 180, and this avoids placing a magnetometer 110 on or near each wheel 20, or to avoid the need to stop the rail cars 10.

In an embodiment, the collected signals from magnetic sensors 110 and proximity sensors 170 are transmitted through a cable to a high speed acquisition system. The power for the sensors is also provided through the cable. The collected data are further processed by a processor 150 of the system 100, such as a computer, for further processing and identify flaws and characteristics of the damage in each wheel 20.

The data from the sensors 110 may be sent through a cable to a high speed acquisition system nearby, in view of the amount of data and the requirement for power at the sensors. The plurality of magnetic field sensors 110 and proximity sensors 170 may also be in wireless communication with the processor.

In use, each magnetometer 110 captures magnetic field information related to the train wheels at a predetermined sample rate. The sample rate may be adjusted to accommodate faster or slower trains.

With the signals collected from the sensors 110, the spatial gradients of the magnetic fields can be calculated to assist in determining the height above the rail surface of the wheel the damage exists. For example, if increasing the separation between the minuend and subtrahend points used in calculating the gradient results in a decrease in the amplitude of the anomaly resulting from damage, then the damage must be near the perimeter of the wheel. If the amplitude increases with increased spatial separation between the minuend and subtrahend points used in calculating the gradient, then the damage must exist at a point above the perimeter of the wheel. The choice of the separation between the points is constrained by the distance between magnetometers placed.

If the damage is located, for example, halfway between the rim of the wheel and the axle of the wheel, then the anomaly as detected by the magnetometers 110 will be “spread out” because the wheel is rolling along its rim, meaning that relative to the rim, the anomaly is moving more slowly towards the low point, and more slowly away from the low point where the magnetometers 110 are positioned. This behaviour can be identified by further analysis of the relative behaviour of the signal amplitude as the wheel rolls past the row of fixed magnetometers 110.

Another feature of the actual anomalous signal detected from a damaged wheel is that the pattern of the signal generated will change as the applied stress changes from compression on the bottom of each rolling point, to extension at the top of each rolling point. This action will produce an exaggeration of the cyclic behaviour of the signal as the stress field affecting the damaged area is changed during rolling.

The system of the present disclosure can also determine the relative size of the defect by the size of the field created as well as relative height.

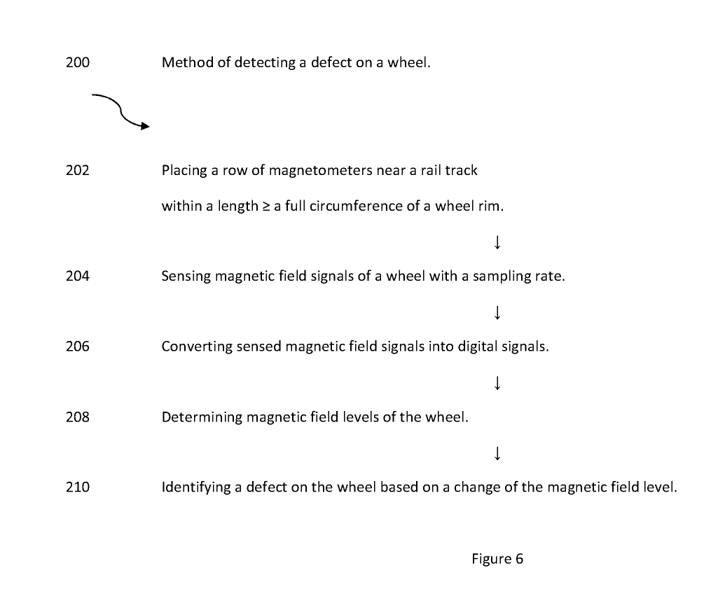

FIG. 6 shows the steps of a method 200 for detecting a defect of a wheel of a rail car according to one embodiment of the present disclosure. The method comprises placing a row of magnetometers near a rail track within a length ≥a full circumference of a wheel rim (202); sensing magnetic field signals of a wheel with a sampling rate (204); converting sensed magnetic field signals into digital signals (206); determining magnetic field levels of the wheel (208); and identifying a defect on the wheel based on a change of the magnetic field level (210).

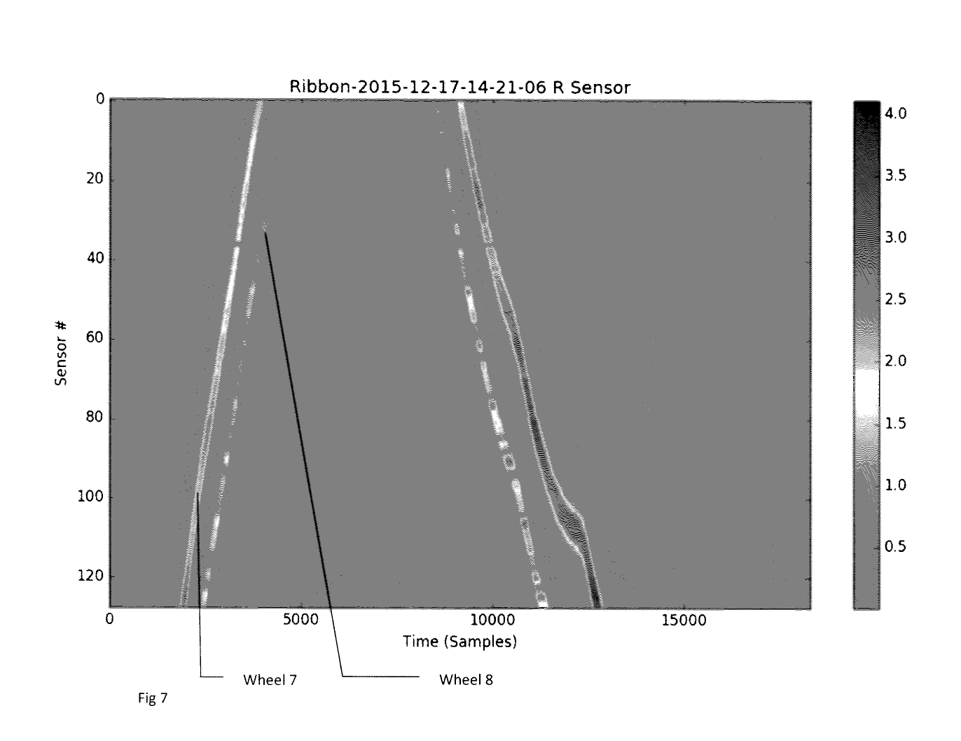

Various experimental tests were conducted at a site closed to the public and under confidential conditions and the results of these experiments are presented in FIGS. 7 to 14. FIGS. 7 to 14 show various plots of the analysis of various wheels using the method and system for identifying and locating defects in a train wheel according to the present disclosure. In these experiments, the sensor 110 was one linear array about 20 ft. long (i.e. a length sufficient to track two complete revolutions of each wheel). A rail truck 10 with two axles and four wheels 20 was rolled along the rail 30, each time with various arrangements of the wheels 20 in proximity to the sensor array 110.

A pair of wheels 20 (i.e. a lead wheel and a following wheel) is sequentially moved into the detection area of a plurality of sensors 110 arranged on the field and gauge side of the wheel as indicated. As the lead wheel 20 enters the detection area, magnetic field measurements are sampled. After a period of time, the following wheel will enter the detection area and magnetic field measurements are sampled.

Once the following wheel reaches the end of the detection area, the direction of the wheels is then reversed and now they move in the opposite direction, whereby the following wheel now reenters the detection area first and the leading wheel reenters the detection a short time afterwards. Additional magnetic field measurements are sampled. The relative changes over the entire range of measurements made are plotted against distance or time. The values of the measurements are plotted with reference to the absolute maximum value sampled and an assignment of a colour code to visualize the results.

From the plots shown in FIGS. 7 to 14, it will become apparent that wheel numbers 8 and 16 are new wheels with no defects. On the other hand, wheel numbers 1, 2, 7, 13, 14, and 15 are wheels having one or more known defects, wherein the center of the defect is identifiable from an area of maximum disturbance.

While visual plots can hold significant value in themselves, the present disclosure provides for improved automation of anomaly detection and/or improved accuracy of anomaly detection/quantification according to the processes to be carried out using a computer and computer software. The software can process the raw data sets by automatically identifying features in the data indicative of anomalies.

In one embodiment, such features are identified by setting a threshold value(s) (which can either be a value above or a value below a baseline level which comprises background fluctuations in the magnetic field measurements) of magnetic field levels or their gradient. Thus, the software can interrogate the raw data entries and identify anomalies where the values are equal to or exceed the threshold value. When the threshold value is above the baseline level, the expression to exceed the threshold value is taken to mean a value that is more positive than the threshold value and thus more positive than the baseline level. By extension, when the threshold value is below the baseline level, the expression to exceed the threshold value is taken to mean a value that is more negative than the threshold value and thus more negative than the baseline level. Additionally, the features in the data indicative of anomalies can also be identified by setting a range of threshold values.

In another embodiment, the user may set the threshold value or the range of threshold values, for example based on experience, such that it is above the background fluctuations in the magnetic data. The centre of any peaks or local maxima (e.g. spikes) in the absolute gradient and/or resultant fields away from the threshold value(s) will thus be defined as a wheel having one or more defects.

In other embodiments, gradients can be generated using the sampled magnetic field measurements to generate a plot of the gradients against distance to obtain additional insight into the nature of the defect. Furthermore, using the method and systems according to the present disclosure, it will now be possible track over a period of time the changes seen in the measured magnetic field and identify any new defects in a structure that appear over time. By tracking the development of defects over time, it is also expected that enough information can be captured to eventually determine if the structure is aging normally, or abnormally for the duration and length of time the wheel or axle are in service.

The embodiments of the present application described above are intended to be examples only. Those of skill in the art may effect alterations, modifications and variations to the particular embodiments without departing from the intended scope of the present application. In particular, features from one or more of the above-described embodiments may be selected to create alternate embodiments comprised of a subcombination of features which may not be explicitly described above. In addition, features from one or more of the above-described embodiments may be selected and combined to create alternate embodiments comprised of a combination of features which may not be explicitly described above. Features suitable for such combinations and subcombinations would be readily apparent to persons skilled in the art upon review of the present application as a whole. Any dimensions provided in the drawings are provided for illustrative purposes only and are not intended to be limiting on the scope of the invention. The subject matter described herein and in the recited claims intends to cover and embrace all suitable changes in technology.

1. A method for identifying and locating a defect in a train wheel or an axle of a train as the train moves along a rail track, the method comprising the steps of:
sampling magnetic field measurements obtained from a plurality of magnetometer sensors so arranged to be in proximity to a moving wheel or an axle, the sensors arranged to span at least a length sufficient to obtain the magnetic field measurements from the entire wheel or the axle during one complete revolution of the wheel or the axle; and
identifying and locating a defect in the wheel or the axle when a sampled magnetic field measurement is equal to or exceeds a threshold value.

2. (canceled)

3. The method of claim 1 wherein the defect is in the wheel and wherein the length is a distance about equivalent to at least about one revolution of the wheel.

4. The method of claim 3 further comprising the step of determining the speed of the wheel and the time the wheel passes in proximity to the plurality of magnetometer sensors.

5. The method of claim 3 further comprising the steps of:
plotting the sampled magnetic field measurements against distance or time to obtain a map showing the changes in magnetic field levels throughout the wheel; and
analyzing the map to identify the defect on a section on the wheel.

6.-7. (canceled)

8. The method of claim 3 further comprising the step of comparing the levels of the magnetic field measurements sampled from a first array of magnetometer sensors arranged to face a field side of the wheel with the levels of the magnetic field measurements sampled from a second array arranged to face a gauge side of the wheel to determine whether the location of the defect is proximal to the field side or proximal to the gauge side.

9. (canceled)

10. An apparatus for identifying and locating defects in a train wheel or an axle of a train as the train moves along a rail track, the apparatus comprising:
a plurality of magnetometer sensors, the sensors arranged to measure magnetic field components in a plurality of directions, the sensors arranged in an array a length sufficient to measure the magnetic field components from the entire wheel or axle during one complete revolution of the wheel or axle.

11. The apparatus of claim 10 wherein the defect is in the wheel and the length is a distance about equivalent to at least about one revolution of the wheel.

12. The apparatus of claim 10 wherein the defect is in the axle and wherein the length is about the length of the axle.

13. A system for identifying and locating defects in a train wheel or axle of a train as the train moves along a rail track, the system comprising:
a plurality of magnetometer sensors, the sensors arranged to measure magnetic field components in a plurality of directions, the sensors arranged in an array having a length sufficient to measure the magnetic field components from the entire wheel or axle during one complete revolution of the wheel or axle;
a processor; and
a non-transitory computer readable media having instructions stored thereon which when executed cause the processor to:
sample the magnetic field measurements;
identify and locate a defect when a sampled magnetic field measurement is equal to or exceeds a threshold value.

14. The system of claim 13 further comprising a data acquisition system for collecting the analog output signal of the sensors, an analog to digital converter for digitizing the analog output signal of the sensors, a memory, and processor arranged to write a plurality of sensor signals to the memory.

15. The system of claims 13 further comprising a proximity sensor to detect the presence of the wheels.

16. The system of claim 13 further comprising a hot box detector to associate the magnetic field measurements with an individual train wheel.

17. The system of claim 13 wherein the threshold value is a value above or below the background fluctuations in the magnetic field measurements.

18. (canceled)

19. The system of claim 13 wherein the defect is in the wheel and the length is a distance about equivalent to at least about one revolution of the wheel.

20. The system of claim 13 wherein the defect is in the axle and wherein the length is about the length of the axle.

21. A non-transitory computer readable medium having instructions stored thereon for identifying and locating defects in a train wheel or axle of a train as the train moves along a rail track, the instructions when executed cause a computer to:
sample magnetic field measurements, the magnetic field measurements obtained from a plurality of magnetometer sensors so arranged to be in proximity to a moving wheel or axle, the sensors arranged to span at least a length sufficient to obtain the magnetic field measurements from the entire wheel or axle during one complete revolution of the wheel or axle;
identify and locate a defect when a sampled magnetic field measurement is equal to or exceeds a threshold value.

22. The non-transitory computer readable medium of claim 21 wherein the defect is in the wheel and wherein the length is a distance about equivalent to at least about one revolution of the wheel.

23. The non-transitory computer readable medium of claim 22 further comprising instructions, when executed additionally cause the computer to:
plot the sampled magnetic field measurements against distance or time to obtain a map showing the changes in magnetic field measurements throughout the wheel; and
analyze the map to identify the defect on a section on the wheel.

24. The non-transitory computer readable medium of claim 23 further comprising instructions, when executed additionally cause the computer to:
determine the range of the changes in the magnetic field measurements during one complete revolution of the wheel;
identify one or more maxima in the sampled magnetic field measurements;
generate a visual pattern using the range of magnetic field measurements; and
identify from the visual pattern, the center of the defect using the identified maxima.

25. The non-transitory computer readable medium of claim 22 further comprising instructions, when executed additionally cause the computer to: compare the magnetic field measurements sampled from a first array of magnetometer sensors arranged to face a field side of the wheel with the magnetic field measurements sampled from a second array arranged to face a gauge side of the wheel to determine based on the relative levels of the sampled magnetic field measurements whether the location of the defect is proximal to the field side or proximal to the gauge side.

26.-27. (canceled)
